(19) United States
(12) Patent Application Publication
(10) Pub. No.: US 2011/0066515 A1
(43) Pub. Date: Mar. 17, 2011

(54) Automated electric plug-in station for charging electric and hybrid vehicles

(76) Inventors: Ronald F. Horvath, Racine, WI (US); Barbara L. Jensen, Racine, WI (US); Nancy T. Elsmo, Racine, WI (US); Helen A. Rusk, Racine, WI (US); Douglas L. Andrewski, Racine, WI (US)

(21) Appl. No.: 12/586,047

(22) Filed: Sep. 16, 2009

(51) Int. Cl. G06Q 50/00; H02J 7/00; G06Q 20/00

(52) U.S. Cl. 705/17; 320/109; 180/65.29

(57) ABSTRACT

Provided is an automated plug-in station for charging electric powered vehicles. The station includes a plug apparatus with a plug head that connects to an adapter on the electric powered vehicle and configured to pass electric charge to the battery of the electric powered vehicle. The plug apparatus extends automatically from a basin once proper alignment is established by a positioning system. Prior to charging, the plug apparatus is enclosed within the basin by a cover door which opens by an actuator when a vehicle enters the station; and when charging is complete, the plug automatically disconnects from the vehicle and withdraws back into the basin. The plug-in station also provides for receiving and processing payments at a payment system in the station.

### BACKGROUND OF THE INVENTION

The present invention relates to systems and methods for charging an electric and/or hybrid vehicle. In particular, this invention relates to automated systems and methods for charging (or recharging) electric and hybrid vehicles at charging stations.

The use of electric powered vehicles for transportation of both people and goods has become increasingly popular with rising concerns over the increasing costs of fuel and the poor environmental conditions caused by combustion engines. In 2006, there were an estimated 53,500 electric and hybrid vehicles in use in the United States. A hybrid vehicle typically includes more than one power source, such as an internal combustion engine and an electric motor with battery, e.g., fuel cells, for energy storage, for example.

Research indicates that several automobile manufacturers have plans to release new electric and/or hybrid models, greatly increasing the presence of electric powered vehicles in the coming years. In addition, battery technologies have improved to allow faster charging times. It is therefore advantageous to make the use of these vehicles as convenient as possible.

Currently, electric powered vehicles can generally run between 100 and 200 miles per full charge. While this may be suitable for the daily driving needs of many people, this is about half the range of combustion engine powered vehicles (i.e., gasoline powered). Additionally, while a combustion engine vehicle can be re-fueled in approximately 10 minutes or less, recharging an electric cell (e.g., battery) for an electric powered vehicle typically takes several hours. For example, charging often takes place overnight at the owner's home, or while the vehicle is parked for extended periods of time.

In view of these difficulties associated with the use of vehicles incorporating electric power, a need exists for charging systems and methods with accessibility similar to the common retail gas stations. In addition, there is a need for systems and methods that eases the charging process by requiring minimal manual involvement and a shortened charging period.

### SUMMARY OF THE INVENTION

The present invention satisfies such a need by providing automated systems and methods for plugging in and charging an electric vehicle in a shortened time period.

Systems and methods of an automated plug-in station according to the present invention are anticipated to be as readily available and easily accessible as the common gas station. The charging station may provide wheel guides for an electric vehicle pulling into the station, and means for sensing, such as an electric sensor, may be triggered by the approaching vehicle which may then prompt the automated system. A plug apparatus may utilize positioning means to align the plug apparatus with an adapter on the vehicle, e.g., mating plug, connected to the battery or batteries of the vehicle. When properly aligned, the plug extends upwardly or outwardly or downwardly to connect with the adapter and charging may begin. When charging is finished, or at some other predetermined time or charge amount, for example, the plug automatically retracts. Payment for charging may be made at the plug-in station, and may be made conveniently through use of payment means, such as a computer system/terminal located at and/or within the plug-in station.

As an alternative to or in combination with use of conventional line power sources, the present invention has embodiments that are capable of using other alternative energy sources such as solar and/or wind power as a natural power source. These alternative energy sources may also be used to provide power to station lighting, payment means, and/or actuation of components of the automated systems and methods, as non-limiting examples.

One aspect of the invention provides devices, systems, and methods comprising an automated charging station for electric powered vehicles. The automated charging station comprises a plug apparatus having a plug head configured for transfer of electricity, a vehicle adapter for operative connection between said plug head and battery of the vehicle, and a structure to accommodate the plug apparatus and the vehicle for charging.

Another aspect of the invention provides devices, systems, and methods comprising an automated electric powered vehicle charging station. The station comprises guide means for guiding the vehicle to a predetermined location, the location adapted for charging the vehicle, a movable plug apparatus having a plug head configured for transfer of electricity, a basin for housing the movable plug apparatus while not in use, positioning means for positioning the plug head for mating with a vehicle adapter, and a structure to accommodate the plug apparatus and the vehicle for charging.

Yet another aspect of the invention provides devices, systems, and methods comprising a method for charging an electric powered vehicle. The method comprises sensing a vehicle in a predetermined location, the location adapted for charging at least one power cell of the vehicle, opening a door to allow a plug to extend to the vehicle, extending the plug to an adapter on the vehicle, the adapter electrically coupled to the at least one power cell, and charging the at least one power cell for a predetermined time.

These and other features and advantages are provided by the current invention for charging electric and hybrid vehicles.

### BRIEF DESCRIPTION OF THE DRAWINGS

FIG. 1 is an illustration of one embodiment of a housing structure of the automated electric plug-in station.

FIG. 2 is a detail view showing one embodiment of an underground basin containing the plug apparatus prior to charging.

FIG. 3 is a detail view showing one embodiment of the underground basin and the plug apparatus when the vehicle is in position and the plug is moving upwardly to connect to the vehicle's battery adapter.

FIG. 4 is a perspective view of one embodiment of the plug apparatus positioning system.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

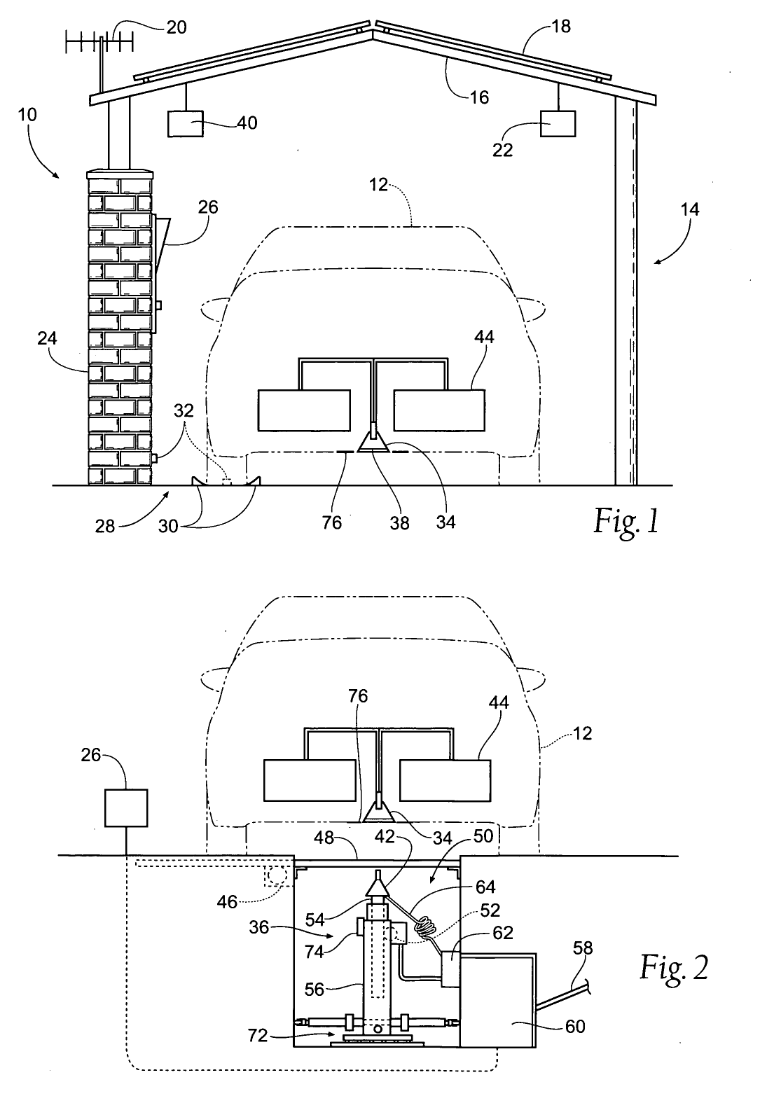

FIGS. 1 and 2 show exemplary embodiments of an automated electric vehicle plug-in station 10. In FIG. 1, a vehicle 12 incorporating electric power, such as an electric vehicle, or hybrid vehicle, or neighborhood electric vehicle (NEV) is shown parked within a structure 14 of the present invention. The structure 14 may comprise a housing structure, and may include a roof 16 for multiple purposes including protection from natural elements such as wind, rain, and sun, and may also provide a site for natural energy sources 18 such as solar panels and/or wind turbines used to power elements of the station 10, and may also provide a site for an antenna 20 for communications, and lighting 22, for example. While the embodiment shown includes a roof cover 16, the present invention is completely functional without a roof 16 and/or housing structure 14.

In one embodiment, a side barrier 24, e.g., wall, of the housing structure 14 may have payment means 26, such as a computer system, to accept and/or process payment for use of the plug-in station. The payment means 26 may also record usage of the plug-in station with or without accepting payment, and may also communicate across a known and/or future developed network, such as via a local area network (LAN), wide area network (WAN), and/or wirelessly, to another system or network for processing station usage data and/or payments for use of the plug-in station, as non-limiting examples.

In one embodiment, the payment means 26 may need to be accessed, e.g., by proving a credit card or other identification, by the vehicle driver (or occupant) before the plug-in station 10 is activated to couple to the vehicle to charge the vehicle batteries.

It is to be appreciated that the station 10 may have no walls, or one wall, or more than one wall, and may include one or more doors to accommodate a vehicle traveling into and out of the structure 14, and may also include one or more doors to accommodate the vehicle driver and/or passengers into and out of the structure 14.

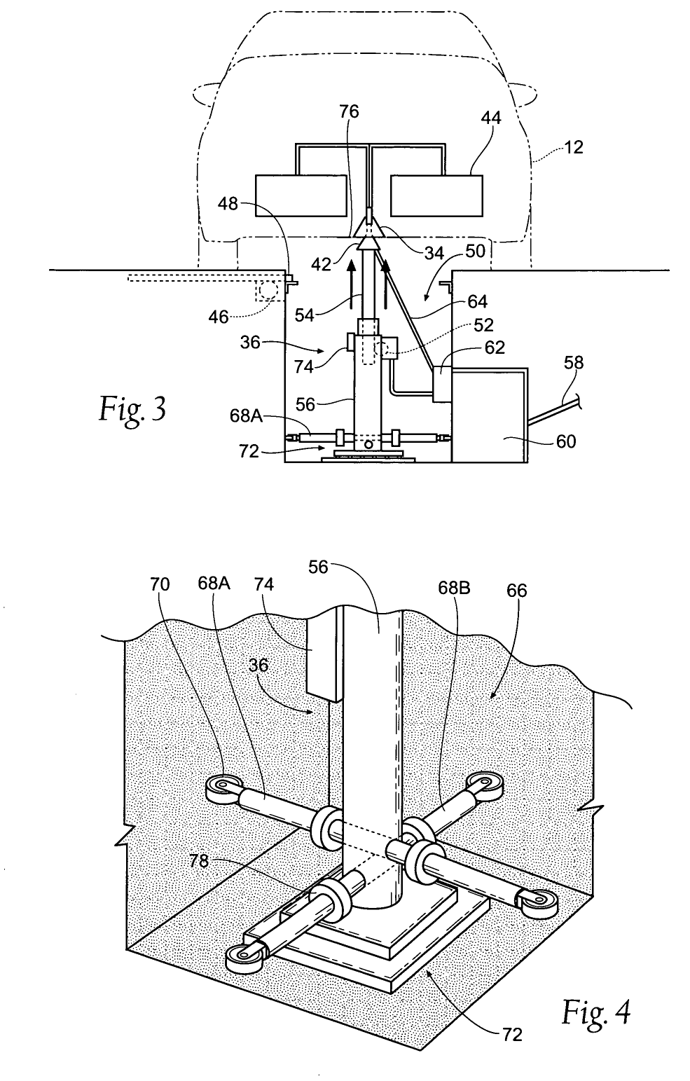

Guide means 28, such as wheel guides 30 and/or sensors 32, for example, may be included prior to and/or within the structure 14 to assist in proper alignment of the vehicle 12, the vehicle including an adapter 34, in relation to the plug apparatus 36 located below the level of the vehicle, e.g., below the ground level (shown in FIGS. 2 and 3). The vehicle adapter 34 may include an anti-dirt and/or moisture cover 38 to protect the adapter 34 while not in use. The adapter may also be positioned in a specific position in relation to the guide means 28 for desired vehicle alignment.

Instructions to the vehicle driver may also be provided using device 40, such as on a video screen and/or through a loud speaker, and may be used to guide the vehicle for desired alignment. The guide means 28 may allow the vehicle driver to remain in the vehicle during the charging process, including driving into the station 10, coupling the plug 42 to the vehicle adapter 34, charging the vehicle batteries 44, disconnecting the plug 42 from the adapter 34, using the payment means 26, and driving away from the station 10.

The present invention may also use the sensor 32 or other trigger device, such as a switch which, when triggered, prompts one or more door means 46 to open and/or close a cover door (or doors) 48 over a basin 50. The means 46 may comprise an actuator, such as an electric (AC or DC) motor, servo motor, hydraulic motor, and pneumatic motor, as non-limiting examples. The sensor 32 may be an element of the guide means 28, or may be a separate component of the plug-in station 10. The cover door 48 may open in a variety of ways, including but not limited to laterally sliding, top and/or side hinged, roller, and the like, and may use at least a first door means for opening and a second door means for closing.

As shown in FIGS. 2 and 3, the underground basin 50 desirably contains apparatus means 52 for extending and/or retracting the plug apparatus 36 to mate with the adapter 34. The means 52 may comprise an actuator, such as an electric (AC or DC) motor, servo motor, hydraulic motor, and pneumatic motor, as non-limiting examples.

In one embodiment, the plug head 42 configured to pass electric charge to the vehicle may be attached atop a moveable shaft 54 held within or to a support base 56. The movable shaft 54 may be inflexible, or may allow for flectional movement to accommodate minor vehicle movements. The means 52 may use a rack and pinion drive to convert rotational motion (i.e., from a motor) into linear motion to extend the shaft 54 and plug 42 upwardly toward the vehicle adapter 34.

Power to the means 46, 52 may be provided by an external source 58, e.g., electric line power which may be AC or DC voltage, but may also be a natural power source such as sun and/or wind power, as previously described. The external electricity 58 may be passed through a transformer 60 and then through a rectifier 62 to convert AC power into DC power.

Similarly, electricity may be provided from the external source 58 through the plug head 42 to charge the vehicle's batteries 44. In one embodiment, the electricity may also pass through the transformer 60 and through the rectifier 62, and then through a flexible cable 64 to the plug head 42.

The present systems and methods for plugging in and charging an electric vehicle may allow for a vehicle to be recharged in about three hours or less, or about one hour or less, or about thirty minutes or less, or about 15 minutes or less, or about 10 minutes or less, or about 5 minutes or less.

When the one or more batteries 44 or battery packs are fully charged, the plug 42 may be retracted from the vehicle adapter 34 and the cover door 48 may close to re-cover the apparatus 36 in the basin 50.

FIG. 4 is a perspective view of one embodiment of a positioning system 66. The plug apparatus 36 may be supported by two rigid beams 684A, 68B situated generally perpendicularly. Spring loaded wheels 70 at the ends of the beams 68A, 68B are adapted for movement of the beams 68A, 68B which further move the plug apparatus 36 in the X-Y directions. Alignment means 72, such as a motor driven X-Y table and/or ball ride on the underside of the apparatus may facilitate the movement of the apparatus 36 to align the plug 42 with the adapter 34 on the vehicle.

In one embodiment, the X-Y table may be eliminated. The ball ride would allow the apparatus 36 to manually adjust itself as it aligns the plug 42 with the adapter 34.

In one embodiment, proper alignment may be achieved by the positioning system 66 for positioning the vehicle in a desired location with the aid of the guide means 28. The adapter 34 may be positioned on the vehicle such that when the vehicle 12 trips sensor 32, for example, the adapter 34 is in the desired position for mating with the plug 42.

In an alternative embodiment, the positioning system 66 may include the use of a cell light 74. Light emitted from the cell light may be reflected back by a reflector 76 to provide coordinates to be used by the motor driven X-Y table. The cell light reflector 76 may be located next to or near the vehicle adapter 34. The cell light 74 may be positioned in the same relative position on the plug apparatus 36. Once properly aligned, the plug apparatus may be locked in place by locking rings 78 located around one or more of the rigid beams 68A, 68B to lock the travel in an X-Y distance.

The plug-in station 10 allows for quick and easy charging of a vehicle. In use, the vehicle is driven onto and/or into the station 10. The vehicle may be guided to a predetermined position so as to provide alignment between the plug apparatus 36 and the vehicle adapter 34. The vehicle driver may then be required to activate the plug-in station by providing a credit card or payment or other information to the payment means 26. The station 10 then automates the charging process by opening a door and extending the plug apparatus 36 and mating the plug 42 with the vehicle adapter 34. The vehicle charges for a predetermined time and/or until the batteries are fully charged. The plug 42 is then withdrawn from the adapter 34 and the door 48 is closed. The payment means may again be activated to complete the charging process. The vehicle may then be allowed to exit the station.

It is to be appreciated that the system 10 may plug into a vehicle adapter positioned in other locations besides under the vehicle as shown. For example, the adapter 34 may be on a side or top or front or rear of the vehicle, as non-limiting examples.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

We claim:

1. An automated charging station for electric powered vehicles, the automated charging station comprising:
a plug apparatus having a plug head configured for transfer of electricity,
a vehicle adapter for operative connection between said plug head and battery of the vehicle, and
a structure to accommodate the plug apparatus and the vehicle for charging.

2. The charging station as defined in claim 1:
wherein the structure comprises at least one side barrier, vehicle alignment means, and sensor means adapted to be triggered by approach and/or position of the vehicle.

3. The charging station as defined in claim 2:
wherein the at least one side barrier includes an electronic payment means.

4. The charging station as defined in claim 1:
wherein the structure includes a roof covering.

5. The charging station as defined in claim 4:
wherein the roof covering includes a panel to generate solar power.

6. The charging station as defined in claim 1:
wherein the plug apparatus is contained in a basin below the vehicle.

7. The charging station as defined in claim 6:
wherein the basin includes a door cover.

8. The charging station as defined in claim 7:
wherein the door cover is adapted to be opened and closed by door means, the door means being powered by an external power source.

9. The charging station as defined in claim 1:
wherein the plug apparatus includes a shaft supporting an electric plug, the shaft being positioned within a supporting base below said vehicle before charging and being moveable to provide operative connection between the plug and the vehicle adapter.

10. The charging system as defined in claim 9:
wherein the shaft is vertically moveable by apparatus means, the apparatus means being powered by an external power source.

11. The charging system as defined in claim 9:
wherein an external power source provides power to be supplied through the plug to the vehicle.

12. The charging station as defined in claim 1:
further comprising a positioning system for locating the vehicle adapter and controlling the movement of the plug apparatus so that the plug is substantially aligned with the vehicle adapter.

13. The charging system as defined in claim 12:
wherein the positioning system comprises moveable support beams positioned generally perpendicularly, moveable by spring-loaded wheels between the support beams and the basin wall, and a movement-facilitating mechanism located on the underside of the plug apparatus.

14. The charging system as defined in claim 13:
wherein the positioning system further comprises a light reflector located beside the vehicle adapter and a light source at a location relative to said plug whereby proper alignment of the plug and the adapter is achieved when reflection occurs.

15. An automated electric powered vehicle charging station comprising:
guide means for guiding the vehicle to a predetermined location, the predetermined location adapted for charging the vehicle,
a movable plug apparatus having a plug head configured for transfer of electricity,
a basin for housing the movable plug apparatus while not in use,
positioning means for positioning the plug head for mating with a vehicle adapter, and
a structure to accommodate the plug apparatus and the vehicle for charging.

16. The charging system as defined in claim 15:
further comprising a structure to accommodate the movable plug apparatus and the vehicle for charging.

17. The charging station as defined in claim 16:
wherein the structure includes an electronic payment means.

18. A method for charging an electric powered vehicle, the method comprising:
sensing a vehicle in a predetermined location, the location adapted for charging at least one power cell of the vehicle,
opening a door to allow a plug to extend to the vehicle,
extending the plug to an adapter on the vehicle, the adapter electrically coupled to the at least one power cell, and
charging the at least one power cell for a predetermined time.

19. A method as defined in claim 18:
further including retracting the plug and closing the door.

20. A method as defined in claim 18:
further including accepting payment via payment means prior to extending the plug.
